(19) United States
(12) Patent Application Publication
(10) Pub. No.: US 2014/0293827 A1
(43) Pub. Date: Oct. 2, 2014

(54) Method And Apparatus For Peer Node Synchronization

(71) Applicants: Sandeep Kumar, Bangalore (IN); Anil Nagarajan, Bangalore (IN); Arvind Kubendran, Bangalore (IN); Jagjeet Bhatia, Bangalore (IN); Edgard Vargas, Calabasas, CA (US); Lathakannan Arumugam, Bangalore (IN); Ashokkumar Rajendran, Calabasas, CA (US)

(72) Inventors: Sandeep Kumar, Bangalore (IN); Anil Nagarajan, Bangalore (IN); Arvind Kubendran, Bangalore (IN); Jagjeet Bhatia, Bangalore (IN); Edgard Vargas, Calabasas, CA (US); Lathakannan Arumugam, Bangalore (IN); Ashokkumar Rajendran, Calabasas, CA (US)

(21) Appl. No.: 13/852,128

(22) Filed: Mar. 28, 2013

(51) Int. Cl. H04L 12/46; H04L 12/24

(52) U.S. Cl. CPC H04L 12/4641; H04L 41/12
USPC 370/254

(57) ABSTRACT

A method and apparatus for facilitating synchronization of network nodes in an MC-LAG (multi-chassis link aggregation) configuration. Each of two nodes communicate with each other in such a manner as to enable data traffic to be handled efficiently by either.

### CROSS-REFERENCE TO RELATED APPLICATIONS

The present disclosure is related to U.S. patent application Ser. No. 13/010,617, entitled Multi-Chassis Inter-Process Communication and filed on 20 Jan. 2011, the entire contents of which are incorporated by reference herein.

### TECHNICAL FIELD

The present invention relates generally to the field of communication networks, and, more particularly, to a method and apparatus for facilitating synchronization of chassis nodes in a multi-chassis link aggregation configuration.

### BACKGROUND

The following abbreviations are herewith defined, at least some of which are referred to within the following description of the state-of-the-art and the present invention.
DHCP Dynamic Host Configuration Protocol
IEEE Institute of Electrical and Electronics Engineers
IETF Internet Engineering Task Force
LDRA Lightweight DHCPv6 Relay Agent
MAC Media Access Control
MAN Metropolitan Area Network
MC-LAG Multi-Chassis Link Aggregation
MVRP Multiple VLAN Registration Protocol
STP Spanning Tree Protocol
VFL Virtual Fabric Link
VLAN Virtual Local Area Network
vNP Virtual Network Profile
WAN Wide Area Network

Computers and computing devices are often connected together through a network so that individual and institutional users can communicate with each other and access remote computing and data storage capabilities. Computer networks originally connected researchers at university, and then at different universities, but nowadays connected users at home or large or small businesses as well. Applications available using computer networks include email, the Internet and World Wide Web, television, and VOiP (voice over Internet protocol). A LAN (local area network) may be used to interconnect individual devices at a home or office. These devices may include one or more gateways for connected the LAN to other LANs or larger networks such as WANs (wide area networks) or MANs (metropolitan area networks). Large carrier network allow data to flow between thousands of individual subscribers and smaller networks.

Networks are made up of nodes such as bridges, switches, and routers, which are configured to received data packaged and addressed according to one or more standard protocols and forward to or toward its intended designation. Because every computer or computing device is not directly connected to every other, data traffic may be received and forwarded by a number of network nodes between source and destination.

In many networks, it is desirable to provide selective redundancy to enable increased capacity and backup in the event of a failure along one data path. For example, a link may be established between an edge node and multiple (typically two) network nodes (see, for example, FIG. 1). In this sense an edge node typically communicates with end devices, for example personal computers or home or business gateways, providing them with access to a larger network. Having a data path through two network nodes provides a redundant data path that can be used when necessary.

Each network node is a physical device housed in a chassis, which may contain a number of such devices. For this reason the arrangement described above may be referred to as MC-LAG (multi-chassis link aggregation). Each of the network nodes involved may be referred to as a peer of the other, and they may be connected to each other so that they may exchange control signals and data traffic when appropriate. Note, however, that notwithstanding this nomenclature, there is no requirement that the peers must be housed in separate chassis. As should be apparent, it may be desirable to synchronize information between the peer nodes in case one does have to assume data forwarding as data paths change due to a failure or planned outage event. These needs and other needs are addressed by the present invention.

Note that the techniques or schemes described herein as existing or possible are presented as background for the present invention, but no admission is made thereby that these techniques and schemes were heretofore commercialized or known to others besides the inventors.

### SUMMARY

The present invention is directed to a manner of providing operational synchronization between chassis of a MC-LAG (multi-chassis link aggregation). In one aspect, the present invention is a method of synchronizing peer nodes in a MC-LAG (multi-chassis link aggregation) configuration in an Ethernet environment including receiving in a second node a request from a first node to create a VLAN (virtual local area network) for a user device, determining by the second node whether the user device has been authorized in the second node, and creating the VLAN if it is determined that the user device has been authorized in the second node. The process may further include determining whether the VLAN for the user device exists in the second node and wherein creating the VLAN is only performed if it is determined that the VLAN does not exist on the second node. The method may also include sending from the first chassis to the second chassis the request to create a VLAN for the user device. The process may also include dropping the request if it is determined that the user device has not been authorized in the second node.

In some embodiments, the method may also include determining whether the user device has been authorized comprises determining whether a profile for the user device exists on the second node. In this embodiment, the method may further include receiving in the second node a request to create a profile for a user device, determining if a profile for the user device exists in the second chassis, and creating the profile if it does not exist. The method may also include sending the request to create a profile from the first chassis to the second chassis. In a preferred embodiment, the VLAN is a vNP-Dynamic VLAN and the profile is a vNP-Profile, for example according to the AOS (Alcatel-Lucent Operating System).

In another aspect the present invention is an apparatus including a processor and a memory device. The apparatus also includes a network interface permitting the processor and other components to communicate information such as data traffic via, and a plurality of ports in communication with the network interface. In a preferred embodiment, the network also includes a transient entry table for storing, for example, transient entries relating to DHCPV6 requests, a VLAN table is provided for storing dynamic VLAN information, and a profile module is present for storing profile information associated with dynamic VLANs.

Additional aspects of the invention will be set forth, in part, in the detailed description, figures and any claims which follow, and in part will be derived from the detailed description, or can be learned by practice of the invention. It is to be understood that both the foregoing general description and the following detailed description are exemplary and explanatory only and are not restrictive of the invention as disclosed.

### BRIEF DESCRIPTION OF THE DRAWINGS

A more complete understanding of the present invention may be obtained by reference to the following detailed description when taken in conjunction with the accompanying drawings wherein:

FIG. 1 is a simplified schematic diagram illustrating a network having an MC-LAG configuration in which an embodiment of the invention may be advantageously implemented;

FIG. 2 is a flow diagram illustrating a method according to an embodiment of the present invention;

FIG. 3 is a flow diagram illustrating a method according to an embodiment of the present invention;

FIG. 4 is a flow diagram illustrating a method according to an embodiment of the present invention;

FIG. 5 is a flow diagram illustrating a method according to an embodiment of the present invention; and

FIG. 6 is a simplified block diagram illustrating selected components of an apparatus according to an embodiment of the present invention.

### DETAILED DESCRIPTION

The present invention is directed to a manner of providing operational synchronization between chassis of a MC-LAG (multi-chassis link aggregation). This synchronization is particularly advantageous when one chassis or link fails or is otherwise taken out of service and data traffic addressed to one chassis may then be forwarded to a second chassis with no or minimal dropping of packets.

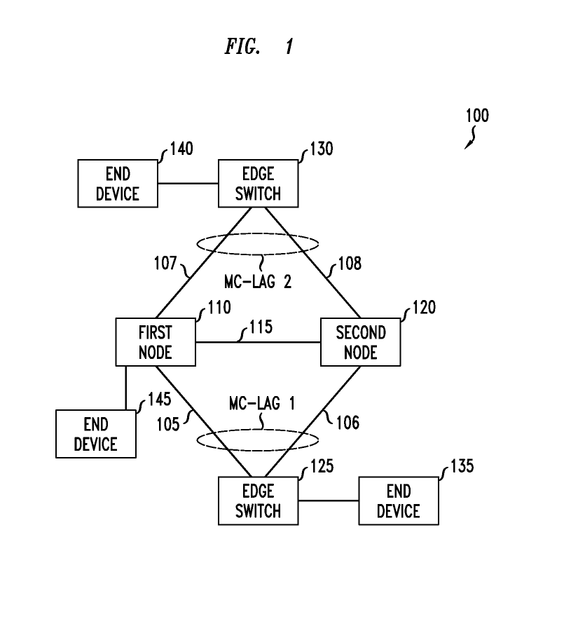

FIG. 1 is a simplified schematic diagram illustrating a network 100 having an MC-LAG configuration in which an embodiment of the invention may be advantageously implemented. As should be apparent, network 100 depicts what is typically only an isolated portion of a larger network, the remainder of which has been omitted for clarity. In the network (or network portion) 100, two MC-LAGs, referred to as MC-LAG 1 and MC-LAG 2 are established. For each of these, a first node 110 and a second node 120 form the “multi-chassis” portion for both MC-LAGs shown in FIG. 1. In this embodiment, first node 110 and second node 120 may communicate with each other over a dedicated link such as a VFL (virtual fabric link) 115. An exemplary configuration and operation of a VFL is described in U.S. patent application Ser. No. 13/010,617, referred to above.

In the exemplary embodiment of FIG. 1, MC-LAG 1 is formed between edge switch 125 and the first node 110 over link 105 and between edge switch 125 and the second node 120 over link 106. Similarly, MC-LAG 2 is formed between edge switch 130 and the first node 110 over link 107 and between edge switch 130 and the second node 120 over link 108. For illustration, end devices 135 and 140 are shown connected to edge switches 125 and 130, respectively. Another end device 145 is shown in direct communication with first node 110. The end devices may, for example, be user devices such as laptop computers or mobile phones.

In an embodiment of the present invention, first node 110 and second node 120 are configured to operate as described below. End device 135 may, for example, communicate with end device 140 via edge switch 125 and first node 110. If the traffic from user device 135 is authenticated and classified into a VLAN that does not exist on first node, then a dynamic VLAN is created and associated with a dynamic profile. The traffic from user device 135 is then forwarded to user device 140 via edge switch 130.

This may continue until such time as a failure occurs, for example, in first node 110 or link 105, at which time traffic from end device 135 to end device 140 is forwarded by edge switch 125 to second node 120. In accordance with the present invention, the traffic is forwarded by second node 120 to edge switch 130 (and from there to end device 140) with little or no interruption because second node 120 was synchronized with first node 110 according to the present invention. Embodiments of this process will now be described.

In another embodiment of the present invention, an end device such as end devices 135 and 145 include DHCPv6 clients and end device 140 is a DHCPv6 server. In this embodiment, first node 110 and second node 120 act to facilitate delivery of a DHCPV6 reply when it must take a different route than did the associated request. This will be explained in further detail below.

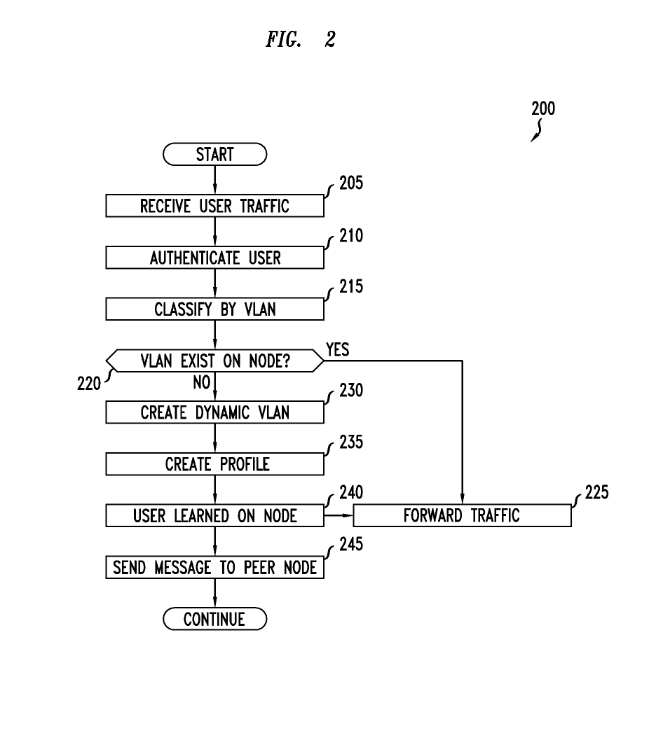

FIG. 2 is a flow diagram illustrating a method 200 according to an embodiment of the present invention. At START it is presumed that the components necessary for performing the process are available and operational according to this embodiment. The process then begins when user traffic is received (step 205) at a network node. This node may be, for example, node 110 shown in FIG. 1 and traffic may be received via an edge switch such as edge switch 125. As should be apparent, the present invention is advantageously implemented where a first network node peers with a second network node in a multi-chassis configuration. Node 120 shown in FIG. 1 may be a second network node in this situation.

In the embodiment of FIG. 2, when the user traffic is received, the user is first authenticated (step 210) and classified (step 215) by VLAN. It is then determined (step 220) if the VLAN exists on the node. If the VLAN does exist, the traffic is forwarded (step 225) normally. If, on the other hand, the VLAN does not exist in the network node, then the node creates (step 230) a dynamic VLAN. In a preferred embodiment, the node implements an AOS (Alcatel operating system), and the dynamic VLAN is a vNP-Dynamic VLAN. In this preferred embodiment, a profile associated with the vNP-Dynamic VLAN is also created (step 235). In the AOS, this is sometimes referred to as a vNP Profile. Of course, a profile may be created for any VLAN associated with embodiments of the present invention.

In the embodiment of FIG. 2, the user traffic may be forwarded (step 220) toward its intended destination. The network node in this embodiment then sends a notification message to a multi-chassis peer node that forms an MC-LAG with the network node. At this point the user device from which the traffic originated is learned (step 240) on the network node and any replies or other communications may be forwarded from the network node to the user. In this embodiment, when the user device is learned on the network node it sends (step 245) a second message to the second (peer) node containing user device information so that the second network node is able to learn the user device as well (not shown).

The process then continues as needed with the later receipt of additional user traffic, if any.

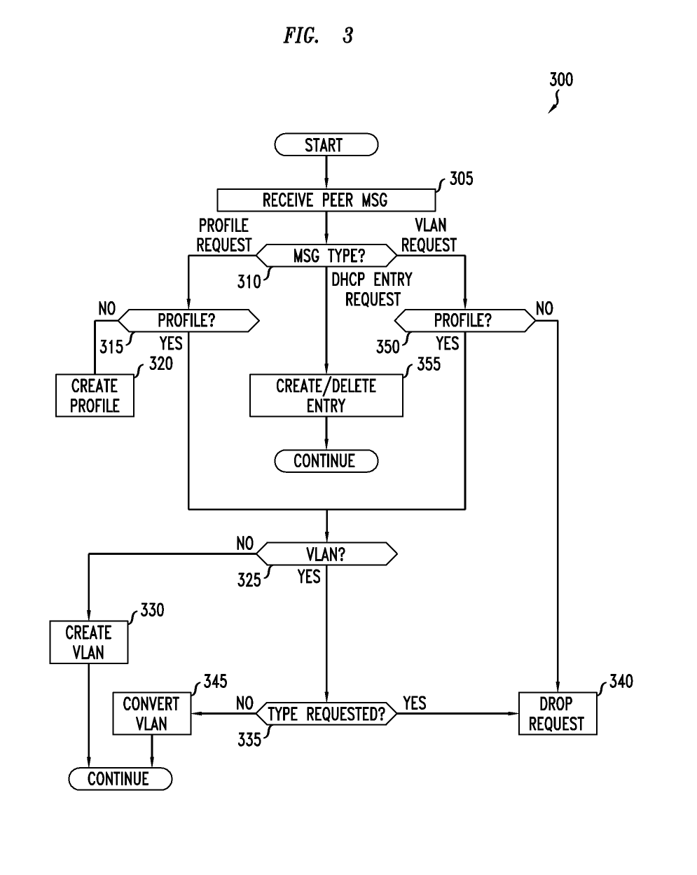

FIG. 3 is a flow diagram illustrating a method 300 according to an embodiment of the present invention. At START it is presumed that the components necessary for performing the process are available and operational according to this embodiment. The process then begins when a message is received (step 305) at a network node from a peer node in an MC-LAG configuration. Consistent with description above, the network node in this embodiment may be the second node 120 shown in FIG. 1, and the message may have originated with network node 110. It should be noted, however, that in most implementations either of the nodes 110 or 120 may employ the methods described herein, depending on their current role in the link aggregation.

In the embodiment of FIG. 3, when the message is received at step 305, the network node determines (step 310) what type of message it is. If it is a request to create a profile, for example a vNP Profile, then the node checks to determine (step 315) if that profile already exists on the node. If not, then the requested profile is created (step 320).

In this embodiment, once the requested profile is extant on the network node, then the node determines (step 325) if the VLAN in the profile exists on the node. If not, then a dynamic VLAN is created (step 330) in accordance with the request. If, on the other hand, the VLAN exists then a determination is made (step 335) as to whether the existing VLAN is if the type requested. If the VLAN associated with the request received at step 305 exists in the type requested, the request may simply be dropped (step 340). If it is determined at step 335, however, that the requested VLAN is extant on the node but is not the type of VLAN requested, then the existing VLAN is converted (step 345) into the requested VLAN-type.

In some cases, as mentioned above, the VLAN may already exist but may be converted at step 345. In a preferred embodiment, for example, if the existing VLAN is an MVRP dynamic VLAN, it is converted to a vNP-Dynamic VLAN. In this preferred embodiment, other types of VLANs, for example static VLANs, are not converted.

In the embodiment of FIG. 3, if the request received at step 305 is determined at step 310 to be a VLAN creation request, then the network node checks to determine (step 350) if a profile associated with the VLAN is extant on the node. If there is no profile associated with the requested VLAN that is extant on the node, then the request is simply dropped (step 340). If, on the other hand, the profile is extant on the network node, then the process proceeds to step 325, determining if the requested VLAN is extant on the node.

In some implementations, the request received at step 305 may be a transient entry request, requesting either the creation or deletion of a transient entry, for example a DHCPv6 entry. In that case, the entry in question is either created or deleted (step 355), as appropriate. This portion of the process will be further described below.

The process then continues with the receipt, if any, of another message from a peer node in the multi-chassis aggregation.

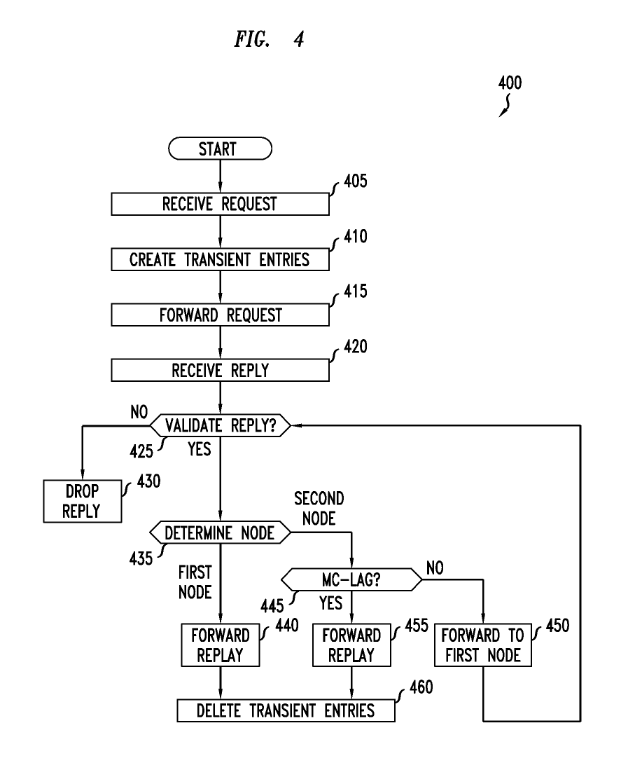

FIG. 4 is a flow diagram illustrating a method 400 according to an embodiment of the present invention. At START it is presumed that the components necessary for performing the process are available and operational according to this embodiment. The process begins when a request is received (step 405) at a first node in a multi-chassis link aggregation having a first peer node and a second peer node. Note that the first node is so designated in describing this process because it has received the request; preferably either of the peer nodes could act as a first node in the processes described herein. In some implementations, there may be more than two peer nodes.

In the embodiment of FIG. 4, transient entries are created (step 410) in the first and second nodes and the message is forwarded (step 415) toward its destination. When a reply is received (step 420) in one of the peer nodes, it is validated (step 425) against the transient entry table. If the reply cannot be validated it is dropped (step 430).

In accordance with the present invention, when the reply is validated, then the receiving node determines (step 435) whether is it a first or second node with respect to the reply. That is, the node determines whether the request associated with the reply was first received in the reply-receiving node or in a peer node. If the receiving node is the first node, then the reply is forwarded (step 440) toward its destination. If the receiving node is a second node, then the reply-receiving node determines (step 445) if the data traffic is associated with the MC-LAG. In most cases this involves determining if the forwarding port is of the link aggregation type.

In the embodiment of FIG. 4, if the reply is not associated with the MC-LAG it is forwarded (step 450) to the first node, from which it can be forwarded toward the requesting device (not separately shown). In this embodiment, the reply received from the second node goes through the same processing in the first node beginning with validation at step 425. In other embodiments (not shown) the reply may be considered validated because it was received from the second node. In the embodiment of FIG. 4 if the reply is associated with the MC-LAG, then it is forwarded (step 455) along the aggregation link toward the requesting device. The transient entries associated with the request and reply may then be deleted (step 460).

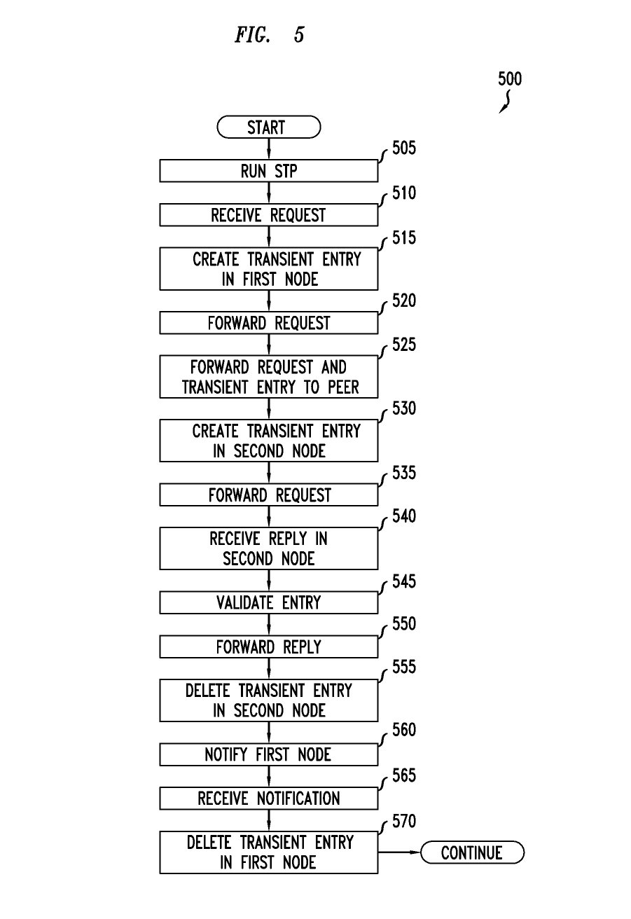

FIG. 5 is a flow diagram illustrating a method 500 according to an embodiment of the present invention. At START it is presumed that the components necessary for performing the process are available and operational according to this embodiment. The process then begins when selected components of an established MC-LAG run an instance of STP (step 505). Here, STP is being used to refer to spanning tree protocol in any of its variations. In other implementations other loop-prevention techniques may be used as well. As a result of running STP, one or more ports will be blocked (not separately shown) to prevent loops from occurring in the MC-LAG.

In this embodiment, for convenience the present invention will be described in terms of device 135 (referring to FIG. 1) including a DHCPv6 client sending a request to device 140, which includes a DHCPv6 server. A reply subsequent to the request is then expected from the device 140 DHCPv6 server. In addition, it is again presumed that the first node 110 will carry the data traffic and the second node 120 is available in the event of a failure of first node 110 or similar event. Of course, an alternate data path arrangement (for example, with node 120 as the first node) will in most cases be accommodated with the corresponding components of network 100 performing analogous tasks. In the flow currently being described, the port of second node 120 associated with link 108 has been blocked (not separately shown) following step 505 for MC-LAG 1.

In the embodiment of FIG. 5, the process continues when the first node 110 receives the DHCPv6 request (step 510) from DHCPv6 client on device 135 via edge switch 125 on link 105. The first node then creates a transient entry (step 515) that contains, for example, the client link-local address, port and VLAN associated with the request. The request packet is then forwarded (step 520) toward its intended destination, which in this case is a DHCPv6 server in device 140. Referring to FIG. 1, this may be by transmission to edge switch 130 on link 107, from which it may be forwarded (not shown in FIG. 5) to device 140, in this embodiment a DHCPv6 server.

In accordance with the embodiment of FIG. 5, the first node 110 also sends the request packet and transient entry to second node 120 (step 525). This transmission may be via the VFL link 115 or another link such as a TCP socket (not separately shown) opened between the first node and the second node. The second node then creates a transient entry (step 530) based on the transient entry received from the first node and attempts to forward the packet (step 535). Note that in this embodiment, the forwarding at step 535 is expected to be unsuccessful because the relevant port has been blocked following the STP or other loop prevention protocol performed at step 505.

In normal operation absent some aberrant event a reply from the DHCPv6 server is expected to be received at first node 110, where it is processed (see FIG. 4). For purposes of illustration, however, it is presumed that link 107 has failed. MC-LAG 2 (via which the reply is expected) directs the reply instead to second node 120 via link 108.

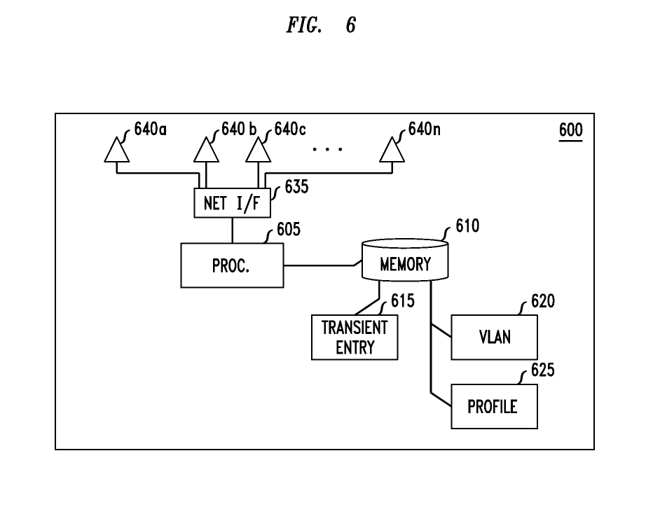

In the embodiment of FIG. 5, when reply is received (step 540) at the second node then validated (step 545) against a transient entry table of the second node (see FIG. 6). Here it is noted that (assuming the reply to be a valid one), the entry will be present because it was added at step 530 in accordance with the present invention. Note also that any invalid replies received will simply be dropped (not shown) by the second node.

In the embodiment of FIG. 5, the validated reply is then forwarded (step 550) toward its destination (see for example steps 435 to 455 shown in FIG. 4). The transient entry is deleted (step 555) from the second node and a notification is sent (step 560) to the first node. Note that the manner of notification may vary on whether the reply is forwarded to the edge device 125 (shown in FIG. 1) for example for delivery to a DHCPv6 client on end device 135, or to first node 110, for example for delivery to a DHCPv6 client on end device 145. In the latter case, forwarding the reply to the first node at step 550 may also include, in effect, transmitting the notification.

In any event, subsequent to receipt of the notification (step 565) at the first node, the first node also deletes (step 570) the transient entry associated with the reply. The process then continues with handling of additional requests and replies, if any.

Note that the sequences of operation illustrated in FIGS. 2 through 5 represent exemplary embodiments; some variation is possible within the spirit of the invention. For example, additional operations may be added to those shown in FIGS. 2 through 5, and in some implementations one or more of the illustrated operations may be omitted. In addition, the operations of the method may be performed in any logically-consistent order, including simultaneously, unless a definite sequence is recited in a particular embodiment.

FIG. 6 is a simplified block diagram illustrating selected components of an apparatus 600 according to an embodiment of the present invention. Apparatus 600 may be, for example, a first node or a second node as shown in FIG. 1. In the embodiment of FIG. 6, apparatus 600 includes a processor 605 in communication with a memory device 610. Processor 605 is for controlling some or all of the components of apparatus 600 in their operation according to embodiments of the present invention. Unless otherwise described in a particular embodiment, processor 605 is implemented in hardware or hardware executing program software instructions. Memory device 610 is for storing program instructions for processor 605, if any, and for operation of other components of apparatus 600. Memory device 610 is in this embodiment also for storing data and data traffic being processed by apparatus 600. Memory device 610 is at least in part a physical device but may in some cases also operate partially according to stored program instructions. Memory device 610 is, unless otherwise explicitly stated, non-transitory in the sense of not being merely a propagating signal.

In the embodiment of FIG. 6, apparatus 600 also includes a network interface 635 permitting processor 605 and other components of apparatus 600 to communicate information such as data traffic via, for example, network 100 shown in FIG. 1 via ports 640a through 640n. Shown separately in FIG. 6 are transient entry table 615 for storing, for example, transient entries relating to DHCPV6 requests. A VLAN table is provided for storing dynamic VLAN information, and a profile module is present for storing profile information associated with dynamic VLANs. Note that in other embodiments not all of these components are present. And of course, there may be numerous other components present in apparatus 600.

Although multiple embodiments of the present invention have been illustrated in the accompanying Drawings and described in the foregoing Detailed Description, it should be understood that the present invention is not limited to the disclosed embodiments, but is capable of numerous rearrangements, modifications and substitutions without departing from the invention as set forth and defined by the following claims.

1. A method of synchronizing chassis in a MC-LAG (multi-chassis link aggregation) configuration in an Ethernet environment, comprising:
receiving in a second node a request from a first node to create a VLAN (virtual local area network) for a user device;
determining by the second node whether the user device has been authorized in the second node; and
creating the VLAN if it is determined that the user device has been authorized in the second node.

2. The method of claim 1, further comprising determining whether the VLAN for the user device exists in the second node and wherein creating the VLAN is only performed if it is determined that the VLAN does not exist on the second node.

3. The method of claim 1, wherein the VLAN is a vNP-Dynamic VLAN.

4. The method of claim 1, further comprising dropping the request if it is determined that the user device has not been authorized in the second node.

5. The method of claim 1, wherein determining whether the user device has been authorized comprises determining whether a profile for the user device exists on the second node.

6. The method of claim 5, wherein the profile is a vNP-Profile.

7. The method of claim 5, further comprising receiving in the second node a request to create a profile for a user device.

8. The method of claim 7, further comprising determining if a profile for the user device exists in the second chassis and creating the profile if it does not exist.

9. The method of claim 7, further comprising sending the request to create a profile from the first chassis to the second chassis.

10. The method of claim 1, further comprising sending from the first chassis to the second chassis the request to create a VLAN for the user device.
